(19) United States
(12) Patent Application Publication
(10) Pub. No.: US 2012/0216146 A1
(43) Pub. Date: Aug. 23, 2012

(54) METHOD, APPARATUS AND COMPUTER PROGRAM PRODUCT FOR INTEGRATED APPLICATION AND TASK MANAGER DISPLAY

(75) Inventor: Hannu Juhani Korkonen, Kangasala (FI)

(73) Assignee: Nokia Corporation, Espoo (FI)

(21) Appl. No.: 13/029,918

(22) Filed: Feb. 17, 2011

(51) Int. Cl. G06F 3/048

(52) U.S. Cl. 715/835

(57) ABSTRACT

Provided herein are a method, apparatus and computer program product for integrating application and task manager information display. In particular, the method may include providing for display of available applications and providing for display of active applications, where the available applications and active applications are displayed concurrently within a list, and where the active applications are each depicted with an enhanced icon. The method may also include arranging the available applications and the active applications on a display based at least in part on whether an application is an active application or an available application. An active application may become an available application in response to the application being closed, and the active application enhanced icon of the active application may change to an application icon in response to the active application being closed.

### TECHNOLOGICAL FIELD

Example embodiments of the present invention relate generally to the presentation of information on a display, and more particularly, to a method of presenting information on a display that is representative of available applications and the status of available applications on a display.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices are becoming small, portable computing devices that are capable of running a variety of applications, some of which benefit from a larger display. These devices are comparable in capabilities to laptop or desktop-type computers such that they can execute thousands of available applications. The portability of such devices may be enhanced by reducing their size, and hence, their display size. With limited display capability, only a select number of applications or icons representing applications or other information may be displayed at any given time.

### SUMMARY

In general, an example embodiment of the present invention provides an improved method of integrating an application and task manager information display. In particular, the method of example embodiments may include providing for display of available applications and providing for display of active applications, where the available applications and active applications are displayed concurrently within a list, where the available applications are each depicted with a first type of icon and where the active applications are each depicted with a second type of icon which is different than the first type of icon. The method may also include causing the available applications and the active applications to be arranged on a display based at least in part on whether an application is an active application or an available application. An active application may become an available application in response to the application being closed, and the second type of icon of the active application may change to the first type of icon in response to the active application being closed. The second type of icon may include a snapshot of a current state of the respective active application. Causing the available applications and the active applications to be arranged may further include causing the available applications and the active applications to be arranged according to a hierarchy, where the hierarchy is determined by at least one of frequency of use, alphabetical order, most recent use, user-defined preference, active state, and a predictive model. The method may further include providing for display of folders, where the folders provide access to available applications not displayed. The method may still further include providing for display of a context menu for at least one active application, where the context menu includes virtual keys for at least one command. The at least one command may include at least one of open, close, move, new instance, remove, play, forward, stop, and back.

According to another embodiment of the present invention, an apparatus is provided. The apparatus may include at least one processor and at least one memory including computer program code. The at least one memory and the computer program code may be configured to, with the at least one processor, cause the apparatus to provide for display of available applications and provide for display of active applications, where the available applications and active applications are displayed concurrently within a list, where the available applications are each depicted with a first type of icon and where the active applications are each depicted with a second type of icon which is different than the first type of icon. The apparatus may further be caused to arrange the available applications and the active applications on a display based at least in part on whether an application is an active application or an available application. An active application may become an available application in response to the application being closed, and the second type of icon of the active application may change to the first type of icon in response to the active application being closed. The second type of icon may include a snapshot of a current state of the respective active application. Causing the apparatus to arrange the available applications and the active applications may further include causing the apparatus to arrange the available applications and the active applications according to a hierarchy, where the hierarchy may be determined by at least one of frequency of use, alphabetical order, most recent use, user-defined preference, active state, and a predictive model. The apparatus may further be caused to provide for display of folders, where the folders provide access to available applications not displayed. The apparatus may further be caused to provide for display of a context menu for at least one active application, where the context menu may include virtual keys for at least one command. The at least one commands may include at least one of open, close, move, new instance, remove, play, forward, stop, and back.

A further embodiment of the invention may include a computer program product including at least one computer readable storage medium having computer-executable program instructions stored therein. The computer executable program code instructions may include program code instructions for providing for display of available applications and program code instructions for providing for display of active applications, where the available applications and active applications are displayed concurrently within a list, where the available applications are each depicted with a first type of icon and where the active applications are each depicted with a second type of icon which is different than the first type of icon. The computer program product may further include program code instructions for causing the available applications and the active applications to be arranged on a display based at least in part on whether an application is an active application or an available application. An active application may become an available application in response to the application being closed, and the second type of icon of the active application may change to the first type of icon in response to the active application being closed. The second type icon may include a snapshot of the current state of the respective active application. The program code instructions for causing the available applications and the active applications to be arranged may further include program code instructions for causing the available applications and the active applications to be arranged according to a hierarchy, where the hierarchy is determined by at least one of frequency of use, alphabetical order, most recent use, user-defined preference, active state, and a predictive model. The computer program product may further include program code instructions for providing for display of a context menu of an active application, where the context menu includes virtual keys for at least one command. The at least one command may include at least one of open, close, move, new instance, remove, play, forward, stop, and back.

In yet another example embodiment, an apparatus is provided. The apparatus may include means for providing for display of available applications and means for providing for display of active applications, where the available applications and active applications are displayed concurrently within a list, where the available applications are each depicted with a first type of icon and where the active applications are each depicted with a second type of icon which is different than the first type of icon. The apparatus may further include means for causing the available applications and the active applications to be arranged on a display based at least in part on whether an application is an active application or an available application. An active application may become an available application in response to the application being closed, and the second type of icon of the active application may change to the first type of icon in response to the active application being closed. The second type of icon may include a snapshot of a current state of the respective active application. The means for causing the available applications and the active applications to be arranged may further include means for causing the available applications and the active applications to be arranged according to a hierarchy, where the hierarchy may be determined by at least one of frequency of use, alphabetical order, most recent use, user-defined preference, active state, and a predictive model. The apparatus may further include means for providing for display of folders, where the folders provide access to available applications not displayed. The apparatus may further include means for displaying a context menu for at least one active application, where the context menu may include virtual keys for at least one command. The at least one command may include at least one of open, close, move, new instance, remove, play, forward, stop, and back.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a mechanism by which application and task manager display may be integrated according to an example embodiment of the present invention;

FIG. 3 is an illustration of a device implementing an example embodiment of the present invention;

FIG. 4 is an illustration of a device implementing another example embodiment of the present invention;

FIG. 5 is an illustration of a device implementing another example embodiment of the present invention;

FIG. 6 is an illustration of a device implementing still another example embodiment of the present invention; and

FIG. 7 is a block diagram according to an example method for an integrated application and task management display.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Devices that may benefit from example embodiments of the present invention may include portable devices, such as tablet computers, cellular telephones, portable media devices, or the like, which are enhanced by a graphical user interface presented on a display, such as a touch screen. As portability of these devices often relates to their size, a smaller size may enhance portability while potentially sacrificing the available display area. Therefore it may be desirable to optimize the display to present as much information as possible in an easily intelligible manner.

Some embodiments of the present invention may relate to a provision of a mechanism by which the user interface is enhanced by presenting a menu to a user wherein the menu contains a list of available applications and a list of active applications. Available applications may include applications and functions of a device that are available to be executed or opened by a user or by the device itself while active applications include applications and functions which have been executed and are open or in process on a device. In some embodiments, the available or inactive applications may be depicted with an icon representative of the application (e.g., a first type of icon) while active applications may be represented with an enhanced icon (e.g., a second type of icon that is different than the first type of icon) as will be described further below. Additionally, in the case of a touch screen interface, the icons and enhanced icons of the available applications and active applications respectively may be virtual keys such that they may be selected by a user to effect an action, such as opening an available application. Active applications may be viewed simultaneously with available applications which are not active. The status of the active applications may be presented in the enhanced icon, for example, in the form of a snapshot of the active application.

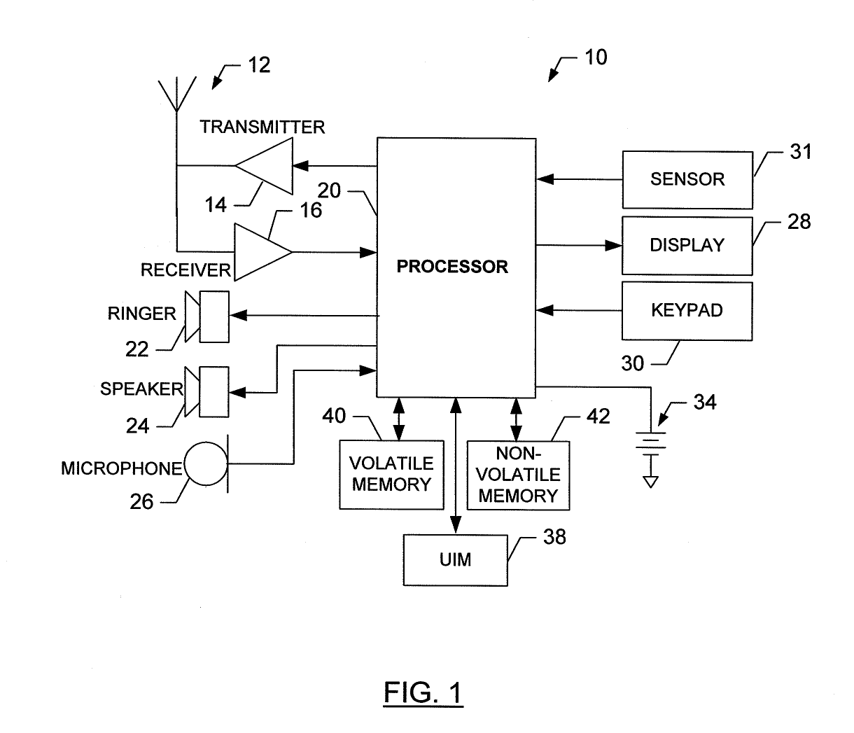

FIG. 1, one example embodiment of the invention, illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

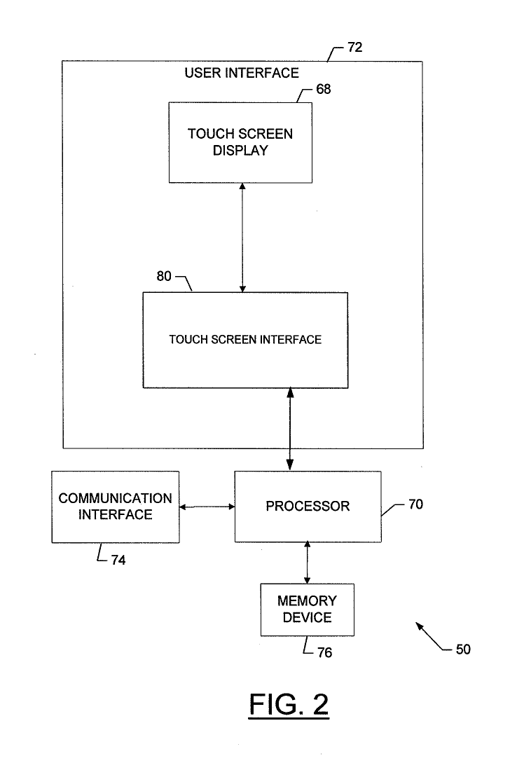

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. Additional input to the processor 20 may include a sensor 31.The sensor 31 may include one or more of a motion sensor, temperature sensor, light sensor, accelerometer, or the like. Forms of input that may be received by the sensor may include physical motion of the mobile terminal 10, whether or not the mobile terminal 10 is in a dark environment (e.g., a pocket) or in daylight, whether the mobile terminal is being held by a user or not (e.g., through temperature sensing of a hand). The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

An example embodiment of the present invention will now be described with reference to FIG. 2, in which certain elements of an apparatus 50 for providing a mechanism by which relevant content may be determined and/or presented are illustrated. The apparatus 50 of FIG. 2 may be a device such as mobile terminal 10 of FIG. 1. However, it should be noted that the present invention may be embodied on any number of devices that include displays.

The apparatus 50 may, in some embodiments, be a mobile terminal (e.g., mobile terminal 10) as illustrated in FIG. 1 or a computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, device surfaces capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a display, such as the illustrated touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications. In one alternative, a touch input may be provided other than by direct interaction with a display (e.g., in cases where the user interface is projected onto a wall with a projector, or where a cursor is used to direct input on the display).

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations.

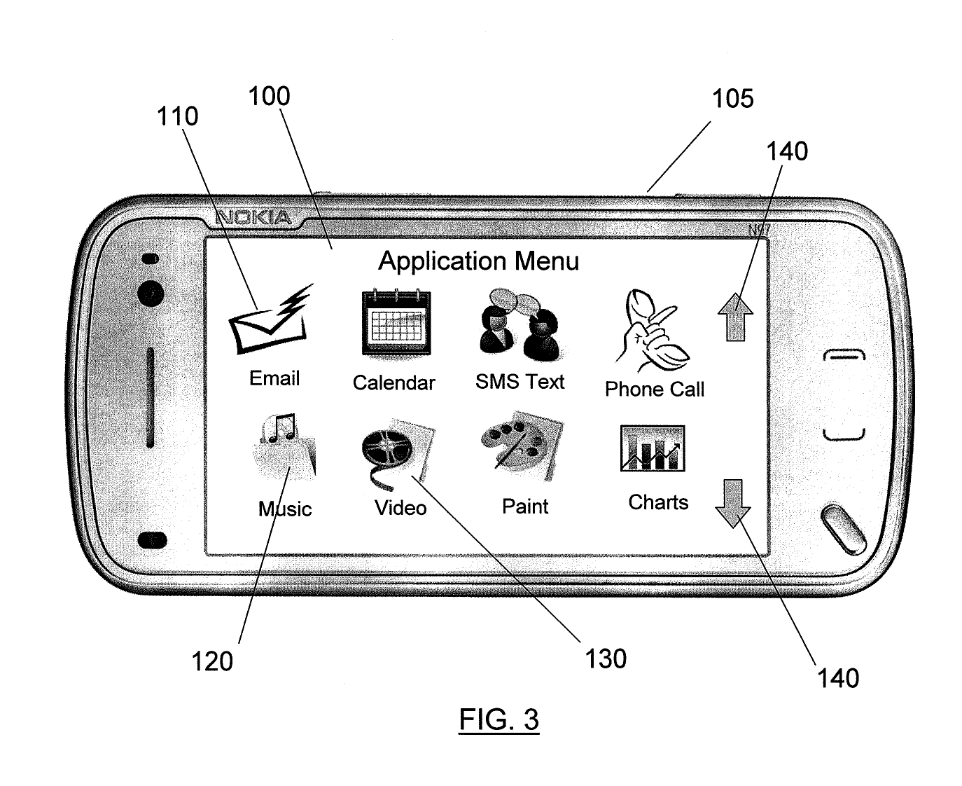

FIG. 3 illustrates a device 105 for providing a mechanism by which both available applications and active applications may be depicted within a single environment. The term “applications” as described herein can refer to any function of a device, such as a media player function, an email program, an internet browser, a device settings manager, or a media library, among many others. As such, the term “application” should not be limited to the embodiments described herein with regard to the example illustrations as any number of functions of a device may be considered an “application.”

FIG. 3 depicts a device, such as a mobile device (e.g., mobile terminal 10), that includes a display 100. The display may be of any known type including touch-screen displays; however, the touch-screen functionality is not necessary to implement example embodiments of the present invention. Depicted on the display 100 is a list of available applications presented as icons 110, 120, 130 in an application menu. The icons 110, 120, 130 may include illustrative figures or symbols indicating to a user an application associated with the icon. For example, an icon representing an email application 110 may include a graphical representation of a traditional postal letter, while an icon representing a music player application 120 may include a graphical representation of a musical note or compact disc. Optionally, the icons may further include names or nicknames adjacent to them indicating to which application each icon is associated. Such text names may be beneficial when multiple email or music player applications are available, or when the device includes a large number of applications. Names or nicknames may also be beneficial for applications for which there is no unique graphical icon available, such as when an application developer has not created a unique icon for an application and/or when the operating system of the device uses a common application icon. Application icons can optionally include an audio clip, video clip, or other multimedia data which may indicate to which application the icon is associated. The display 100 may further include arrows 140 or other indications alerting a user that more applications may exist on the applications menu, each of which may be accessible through a scrolling motion or by switching to another “page” on which applications may be listed. The arrows may be touch-sensitive virtual keys on a touch-screen allowing a user to scroll through available applications by touching the arrows 140. Optionally, applications may be contained within folders whereby a single folder on the top-level application menu may represent a number of application icons. Application icons accessed through a folder may be related by subject, frequency of use, or other means to group applications together.

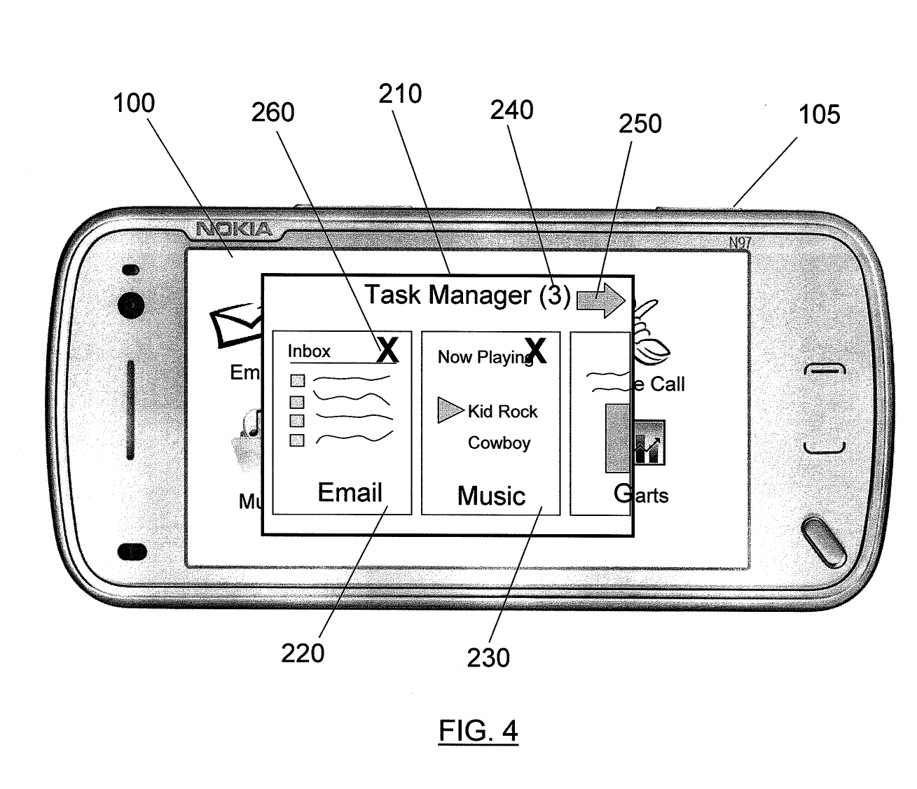

FIG. 4 illustrates a device 105 as shown in FIG. 3; however, the display 100 of the device 105 further includes a task manager 210 superimposed over the application menu of FIG. 3. The task manager 210 may be an application (e.g., one that could be located on the application menu) that provides the current status of all applications that have an active state (e.g., applications which are currently running or open). The task manager itself may be an application, and in the illustrated embodiment of FIG. 4, the task manager 210 is the “primary application” where it is the application that takes precedence over the others, either by being most prominent on the display 100 or by being the active window on the display 100. While superposition of the task manager 210 as the primary application is known in the art, functions of the task manager will be herein described according to example embodiments of the present invention including alternative implementations of the task manager 210 function.

In the illustrated example of FIG. 4, the task manager 210 depicts three active applications as indicated by the number three at 240. The applications may be shown in a list with text, with icons as in the application menu, or optionally with a snapshot of the current status of the active application. A “snapshot” may include a screen-capture or other representation of the active status of the active application. The snapshot may further include how the application would appear if brought to the forefront of the apparatus display 100 (e.g., made the primary active application) at the time when the snapshot was captured (e.g., when the task manager was opened). In the illustrated embodiment, the task manager 210 depicts three snapshots of the active applications. Arrow 250 indicates that additional applications may be viewable in the task manager 210 by scrolling within the task manager. A first active application may be an email application as illustrated at 220. The depicted illustration shows a thumbnail (e.g., small representation) of a snapshot of the email program that has an active state. The snapshot may be updated based on a timer (e.g., every five seconds) or on demand, such as when a snapshot is needed by the task manager 210 for presentation on the display 100, the snapshot may be updated at the time of the request. The snapshots may be updated in real-time (e.g., constantly or whenever a change occurs) in the case of highly dynamic applications. An example of such a highly dynamic application may include a download manager which monitors the status of a file or data being uploaded from a device or downloaded to a device, wherein the progress of the upload or download may be in constant or nearly constant change. A snapshot may be updated in real-time to present the current upload or download progress as it changes. The task manager 210 may be used to observe programs that are currently active. A user may turn off applications to increase available processor capacity or they may switch between active applications using the task manager 210. For example, a virtual key, such as an “X” 260, may be present in the corner of a thumbnail, icon, or snapshot representing the active application. A touch received at the “X” 260 (or a selection cursor-click or equivalent) may close the application associated with that particular thumbnail. Optionally, touching or otherwise selecting a thumbnail 220 or 230 may cause the application associated with the thumbnail to become the primary application.

An available application may be made active when the available application is opened, touched, selected, or otherwise activated by a user initiating the application. The application may become the primary application upon the initiation by the user. However, an available application may also be made active without requiring intervention by a user. For example, an available application may be launched (e.g., opened or activated) by the device itself when an application is required to perform a scheduled task or to complete another function (e.g., a virus scanning application that runs daily). An application may also be launched by a remote request from, for instance, a request over a network. In such instances where an available application is launched other than in direct response to a user request, the application that becomes active may not become the primary application and may run or operate in the background, while the available application icon becomes an active application icon.

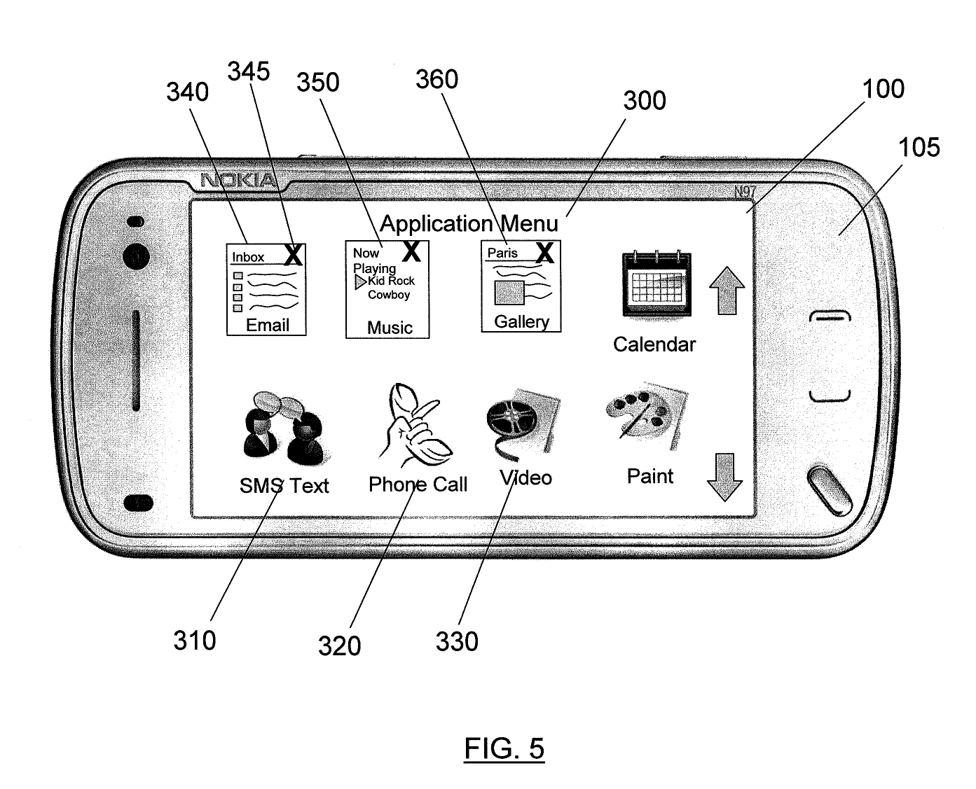

As shown, the task manager 210 of FIG. 4 may supersede or take precedence over the application menu of FIG. 3 and eclipse some or all of the available applications on the application menu. FIG. 5 illustrates an example embodiment of the present invention wherein the application menu 300 of the display 100 presents both available, inactive applications 310, 320, 330, and active applications 340, 350, 360. As illustrated, the original application icon, such as the application icon (e.g., the first type of icon) representing email 120 from FIG. 3 is replaced by an active application icon 340 or enhanced icon (e.g., the second type of icon) depicting an active state. The active state can be represented through a number of different methods as noted with the task manager of FIG. 4. For example, the active application enhanced icon can include a snapshot of a current state of the active application. The active application enhanced icon may further include one or more virtual keys to effect an action on the active application. For example, the active application enhanced icon 345 may include a virtual key “X” as illustrated in the top right corner of the email active application enhanced icon 340. A user may touch or otherwise activate the virtual key “X” 345 to close the email application. In the illustrated embodiment, upon closing the email application, the active application enhanced icon 340 may return to the application icon 120 of FIG. 3 indicating that the application is no longer active. Other virtual keys may be presented within or proximate to the active application enhanced icon, such as a key that, when touched or activated, may cause the active application enhanced icon to be moved within the application menu or may cause the application associated with the active application enhanced icon to become the primary application and open a window for said application. Additional virtual keys may include a “remove” key that may uninstall an application from the device or a “pin” key which “pins” or places an application icon or related application widget on a menu, such as a home menu, of the device.

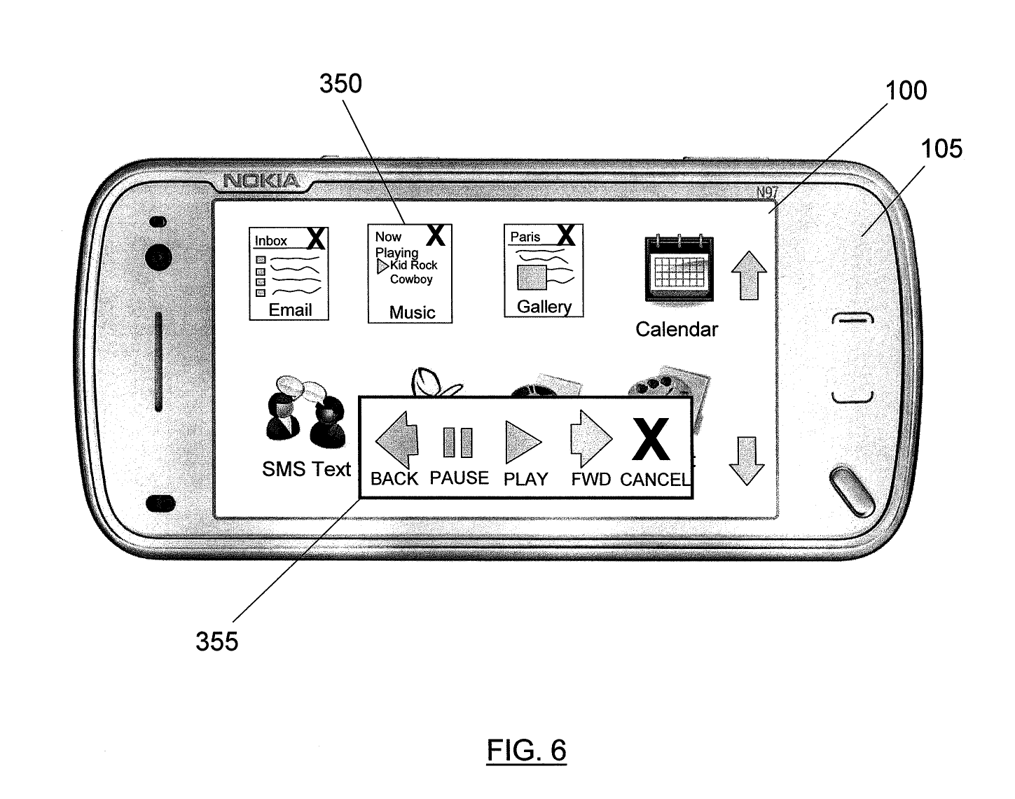

Example embodiments of implementing virtual keys within example embodiments of the present invention may include displaying the virtual keys within or proximate to the active application enhanced icon. However, the virtual keys may also be hidden or not present until a user indicates an application to which they would like to effect a change. For example, if a user touches or otherwise selects a particular active application enhanced icon, such as music application icon 350, a set of virtual keys corresponding to the selected active application enhanced icon may appear, either proximate the active application enhanced icon 350, or anywhere on the display 100. FIG. 6 illustrates virtual keys that may be associated with an active application icon. In the instant example, in response to the music player active application enhanced icon 350 being selected by a user, a set of virtual keys 355 may appear on the display 100. The virtual keys 355 may serve to effect functions of the active application, in this instance a music player, without causing the music player application to be the primary active application and obscuring the application menu. The depicted virtual keys include back, pause, play, forward, and a cancel key that hides the virtual keys 355.

Further example embodiments of the implementation of virtual keys according to embodiments of the present invention may include virtual keys for available application icons. Such virtual keys may include an “updates available” virtual key which may be associated with an available application. Upon selection of an “updates available” virtual key, the available updates for the available application may be performed, such as through a download and install sequence. Further virtual keys that may be available for available applications may include a “recently installed” virtual key signifying that the available application was recently installed and has not yet been launched or activated.

Referring back to FIG. 5, the active application enhanced icons 340, 350, and 360 may be arranged with the application icons 310, 320, 330 in a variety of manners according to a hierarchy. The hierarchy may define which application icon or active application icon is listed first, and the order at which application icons or active application icons descend therefrom. The hierarchy may include a list of rules such as (a) active application icons listed first; (b) active application icons listed by most recently accessed; (c) application icons listed in order of frequency of use, etc. The hierarchy rules may be user-defined or a device according to example embodiments of the present invention may include a number of pre-defined hierarchy options for a user to choose from. Example hierarchies may include: alphabetical order by application name with active applications listed ahead of applications; frequency of use with active applications listed ahead of applications; most recently added applications with active applications listed ahead of applications, etc.

Further example embodiments of the present invention may include hierarchies that are predictive or based upon device awareness. For example, a device according to embodiments of the present invention may include a calendar application to which a user may store meetings or appointments. A meeting or appointment scheduled on the calendar of a user may be scheduled as a video-conference with an agenda for the meeting attached to the appointment as a spreadsheet. The apparatus may be configured with a first hierarchy organizing application icons in alphabetical order, with active application enhanced icons listed first. At the time of the scheduled appointment, or a predefined amount of time there before, the apparatus may switch to a second hierarchy in response to the anticipated appointment without user intervention, organizing application icons according to those that are anticipated for use during the scheduled appointment. In the instant example, the hierarchy may present a video-conference application icon first, a spreadsheet application icon second, and subsequently list the remaining application icons by the first hierarchy.

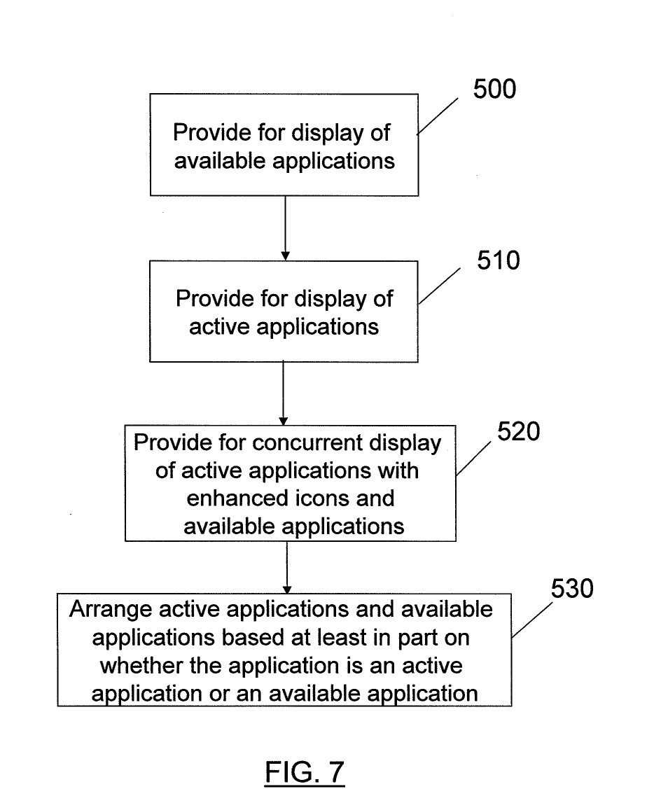

FIG. 7 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user device and executed by a processor in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 7, may include providing for display of available applications at 500, providing for display of active applications at 510, and providing for concurrent display of active applications and available applications at 520. The method may further include arranging the available applications and the active applications on a display based at least in part on whether an application is an active application or an available application at 530.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In some embodiments, the active application becomes an available application in response to the application being closed, and where the active application enhanced icon of the active application changes to an application icon in response to the application being closed. In an example embodiment, the enhanced icon includes a snapshot of a current state of the active application. The concurrent display of available and active applications may be organized by a hierarchy, where the hierarchy is determined by at least one of frequency of use, alphabetical order, most recent use, user-defined preference, active state, and a predictive model. Example embodiments may further include providing for display of folders, where the folders provide access to available applications not displayed. In some example embodiments, a context menu may be displayed wherein the context menu includes virtual keys for at least two commands. The at least two commands may include at least two of open, close, move, and new instance.

In an example embodiment, an apparatus for performing the method of FIG. 7 above may comprise a processor (e.g., the processor 70) configured to perform some or each of the operations (500-530) described above. The processor 70 may, for example, be configured to perform the operations (500-530) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 500-530 may comprise, for example, the motion gesture interface 100 (or respective different components thereof).

An example of an apparatus according to an example embodiment may include at least one processor and at least one memory including computer program code. The at least one memory and the computer program code may be configured to, with the at least one processor, cause the apparatus to perform the operations 500-530 (with or without the modifications and amplifications described above in any combination).

An example of a computer program product according to an example embodiment may include at least one computer-readable storage medium having computer-executable program code portions stored therein. The computer-executable program code portions may include program code instructions for performing operations 500-530 (with or without the modifications and amplifications described above in any combination).

In some cases, the operations (500-530) described above, along with any of the modifications may be implemented in a method that involves facilitating access to at least one interface to allow access to at least one service via at least one network. In such cases, the at least one service may be said to perform at least operations 500 to 530.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of available applications;
providing for display of active applications; wherein the available applications and active applications are displayed concurrently within a list, wherein the available applications are each depicted with a first type of icon and wherein the active applications are each depicted with a second type of icon which is different than the first type of icon; and
causing the available applications and the active applications to be arranged on a display based at least in part on whether an application is an active application or an available application.

2. A method according to claim 1, wherein an active application becomes an available application in response to the application being closed, and wherein the second type of icon of the active application changes to the first type of icon in response to the active application being closed.

3. A method according to claim 1, wherein the second type of icon includes a snapshot of a current state of the respective active application.

4. The method according to claim 1, wherein causing the available applications and the active applications to be arranged further includes causing the available applications and the active applications to be arranged according to a hierarchy, wherein said hierarchy is determined by at least one of frequency of use, alphabetical order, most recent use, user-defined preference, active state, or a predictive model.

5. A method according to claim 1, further comprising providing for display of folders, wherein the folders provide access to available applications not displayed.

6. A method according to claim 1, further comprising providing for display of a context menu for at least one active application, wherein the context menu includes virtual keys for at least one command.

7. A method according to claim 6, wherein the at least one command includes at least one of open, close, move, new instance, remove, play, forward, stop, and back.

8. An apparatus comprising at least one processor and at least one memory including computer program code, the at least one memory and the computer program code configured to, with the at least one processor, cause the apparatus to perform:
provide for display of available applications;
provide for display of active applications, wherein the available applications and active applications are displayed concurrently within a list, wherein the available applications are each depicted with a first type of icon and wherein the active applications are each depicted with a second type of icon which is different than the first type of icon; and
cause the available applications and the active applications to be arranged on a display based at least in part on whether an application is an active application or an available application.

9. An apparatus according to claim 8, wherein an active application becomes an available application in response to the application being closed, and wherein the second type of icon of the active application changes to the first type of icon in response to the active application being closed.

10. An apparatus according to claim 8, wherein the second type of icon includes a snapshot of a current state of the respective active application.

11. An apparatus according to claim 8, wherein causing the apparatus to arrange the available applications and the active applications further includes causing the apparatus to arrange the available applications and the active applications according to a hierarchy, wherein said hierarchy is determined by at least one of frequency of use, alphabetical order, most recent use, user-defined preference, active state, or a predictive model.

12. An apparatus according to claim 8, wherein the apparatus is further caused to provide for display of folders, wherein the folders provide access to available applications not displayed.

13. An apparatus according to claim 8, wherein the apparatus is further caused to provide for display of a context menu for at least one active application, wherein the context menu includes virtual keys for at least one command.

14. An apparatus according to claim 13, wherein the at least one command includes at least one of open, close, move, new instance, remove, play, forward, stop, and back.

15. A computer program product comprising at least one computer-readable storage medium having computer-executable program code instructions stored therein, the computer-executable program code instructions comprising:
program code instructions for providing for display of available applications;
program code instructions for providing for display of active applications; wherein the available applications and active applications are displayed concurrently within a list, wherein the available applications are each depicted with a first type of icon and wherein the active applications are each depicted with a second type of icon which is different than the first type of icon; and
program code instructions for causing the available applications and the active applications to be arranged on a display based at least in part on whether an application is an active application or an available application.

16. The computer program product according to claim 15, wherein an active application becomes an available application in response to the application being closed, and wherein the second type of icon of the active application changes to the first type of icon in response to the active application being closed.

17. The computer program product according to claim 15, wherein the second type of icon includes a snapshot of a current state of the respective active application.

18. The computer program product according to claim 15, wherein the program code instructions for causing the available applications and the active applications to be arranged further includes program code instructions for causing the available applications and the active applications to be arranged according to a hierarchy, wherein said hierarchy is determined by at least one of frequency of use, alphabetical order, most recent use, user-defined preference, active state, and a predictive model.

19. The computer program product according to claim 15, further comprising program code instructions for providing for display of a context menu of an active application, wherein the context menu includes virtual keys for at least one command.

20. The computer program product according to claim 19, wherein the at least one command includes at least one of open, close, move, new instance, remove, play, forward, stop, and back.
